(19) United States
(12) Patent Application Publication
(10) Pub. No.: US 2011/0298577 A1
(43) Pub. Date: Dec. 8, 2011

(54) FUSE WITH COUNTER-BORE BODY

(75) Inventors: Albert Enriquez, Malolos (PH); Cherry Malabanan, Tanauan City (PH); Richard Tacla, Malvar (PH)

(73) Assignee: LITTELFUSE, INC., Chicago, IL (US)

(21) Appl. No.: 13/152,132

(22) Filed: Jun. 2, 2011

Related U.S. Application Data
(60) Provisional application No. 61/351,472, filed on Jun. 4, 2010.

(51) Int. Cl. H01H 85/04

(52) U.S. Cl. 337/186

(57) ABSTRACT

An improved fuse having one or more counter bores in an interior wall of a hollow tube used as the fuse housing. The fuse includes a fusible element disposed within a cavity defined by the interior wall. The fusible element is electrically connected to first and second end caps via solder. The first and second end caps are attached to respective ends of the hollow tube. The one or more counter bores provide more space for the solder to cover the fusible element resulting in a more reliable electrical connection.

### CROSS-REFERENCE TO RELATED APPLICATIONS

This is a non-provisional of pending U.S. Provisional Patent Application Ser. No. 61/351,472, filed Jun. 4, 2010, the entirety of which provisional application is incorporated by reference herein in its entirety.

### BACKGROUND OF THE INVENTION

1. Field of the Invention

Embodiments of the invention relate to the field of circuit protection devices. More particularly, the present invention relates to a fuse having a hollow body that has counter-bored ends to aid in the connection of the fusible element to respective fuse terminals.

2. Discussion of Related Art

Fuses are used as circuit protection devices and form an electrical connection with a component in a circuit to be protected. A fuse includes a hollow fuse body, a fusible element disposed within the hollow body, and two end caps each connected to an end of the fusible element. In particular, FIG. 1 illustrates a prior art fuse 10 having a hollow tubular body 15, a first end cap or terminal 20 and a second end cap or terminal 25. The fusible element 30 is disposed within the hollow body 15 and connects end cap 20 and 25. When an occurrence of a specified fault condition occurs, the fusible element 30 melts or otherwise opens to interrupt the circuit path and isolate the protected electrical components or circuit from potential damage. The hollow tubular body 15 may be ceramic capable of withstanding heat generated when the fuse is blown.

When assembling this type of fuse, consistency and reliability of the solder bonds (as referenced at areas A in FIG. 1) between the fusible element 30 and the end caps 20 and 25 are very important in order to create a robust electrical connection between the terminals. Unfortunately, during assembly there isn't a consistent location where the solder will reflow to achieve a consistent wire to solder connection. In particular, inspection of these fuses occasionally reveals fuses which have inferior wire-to-solder bonds. Thus, there is a need to provide a hollow body fuse configuration that accommodates improved wire to solder connections to repeatedly produce a reliable fuse.

### SUMMARY OF THE INVENTION

Exemplary embodiments of the present invention are directed to an improved fuse having counter bores in walls of a hollow tube used as the fuse housing to provide more space for the solder to cover the fusible element resulting in a more reliable electrical connection. In an exemplary embodiment, the fuse includes a hollow body having two ends where each of the ends has a counter bore configured to receive solder. A fusible element passes through the body. A first and second caps, each disposed on respective ends of the hollow body, wherein the solder forms an electrical connection between each of the caps and the fusible element.

In another embodiment, the fuse includes a hollow body having an interior wall that defines a central cavity where the hollow body has a first end and a second end. A counter bore is disposed within the interior wall at the first end of the hollow body. A solder material is disposed within the counter bore and a fusible element is disposed within the central cavity and extends from the first end of the hollow body to the second end of the hollow body. The fusible element has a first end attached to the solder material proximate the counter bore. The fuse also includes a cap which is attached to the first end of the hollow body where the solder material forms an electrical connection between the cap and the first end of the fusible element.

### BRIEF DESCRIPTION OF THE DRAWINGS

FIG. 1 illustrates a prior art fuse.

FIG. 2A illustrates a side view of a fuse body in accordance with an embodiment of the present disclosure.

FIG. 2B illustrates an end view of the fuse body of FIG. 2A in accordance with an embodiment of the present disclosure.

FIG. 2C illustrates a side view of a fuse utilizing the fuse body of FIGS. 2A-2B in accordance with an embodiment of the present disclosure.

FIG. 3 illustrates a fuse body having an alternative configuration of counter bores in accordance with an embodiment of the present disclosure.

FIGS. 4A, 4B illustrates a fuse body having an alternative configuration of counter bores in accordance with an embodiment of the present disclosure.

FIGS. 5A, 5B illustrates a fuse body having an alternative configuration of counter bores in accordance with an embodiment of the present disclosure.

FIGS. 6A, 6B illustrates a fuse body having an alternative configuration of counter bores in accordance with an embodiment of the present disclosure.

FIGS. 7A, 7B illustrates a fuse body having an alternative configuration of counter bores in accordance with an embodiment of the present disclosure.

FIGS. 8A, 8B illustrates a fuse body having an alternative configuration of counter bores in accordance with an embodiment of the present disclosure.

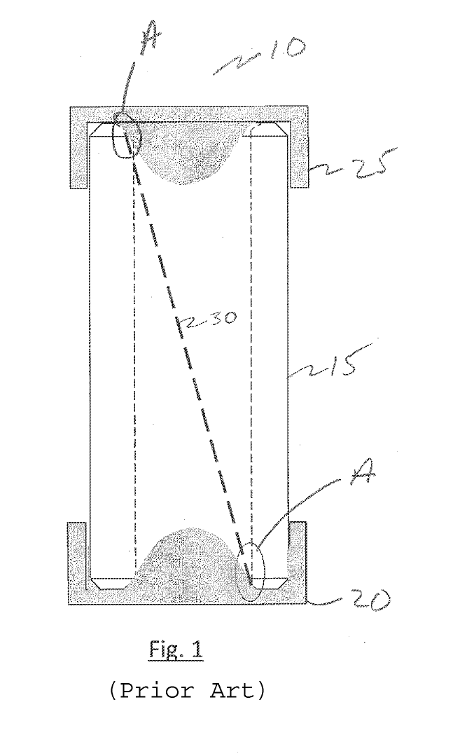

### DESCRIPTION OF EMBODIMENTS

The present invention will now be described more fully hereinafter with reference to the accompanying drawings, in which preferred embodiments of the invention are shown. This invention, however, may be embodied in many different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout.

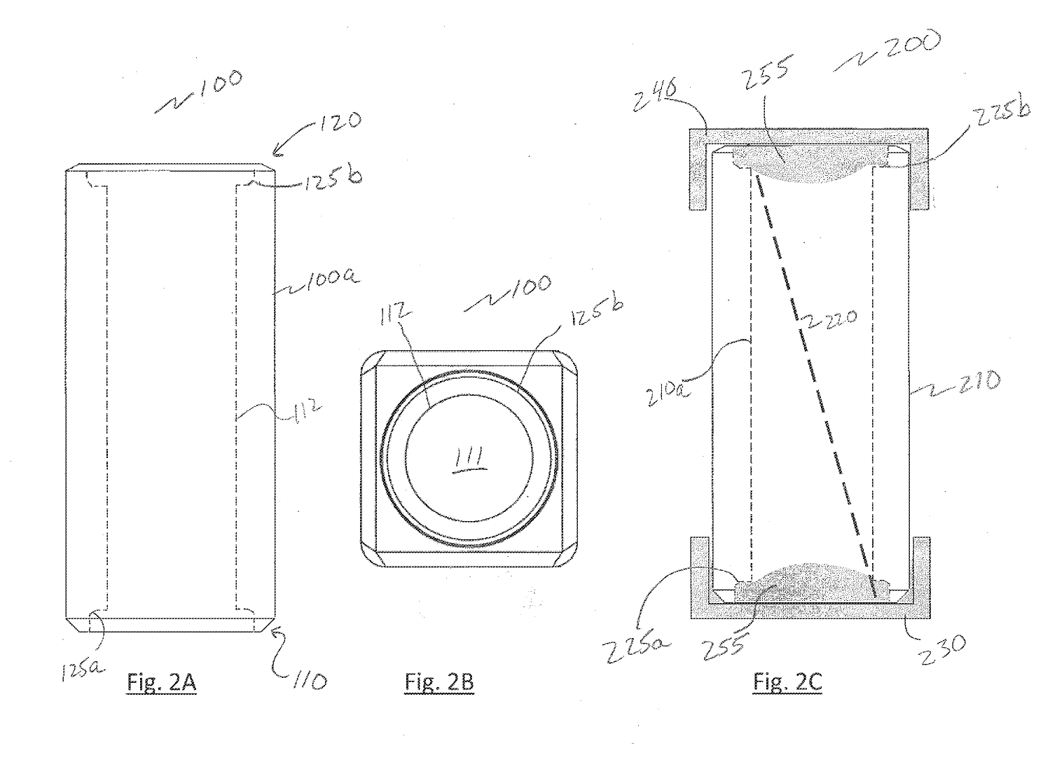

FIG. 2A is a perspective view of a hollow fuse body or tube 100 used for a fuse having walls 100a, a first end 110 and a second end 120. The tube 100 has a generally cylindrical shape which can have a desired cross sectional profile as shown, for example, in FIG. 2B. A cavity 111 is defined by wall 112 where the shape of the tube can be, for example, rectangular, cylindrical, etc., with various cross-sectional configurations. The tube 100 is manufactured from an electrically insulating material, for instance glass, ceramic, plastic, etc. At each end 110, 120 of the tube 100, counter bores 125a, 125b are disposed in the sides of the tube walls 100a. The counter bores 125a, 125b provide a more consistent point of connection between the solder or other conductive material and the fusible element as shown below with reference to FIG. 2C. Although the counter bores 125a and 125b are shown having substantially the same geometry, alternative geometries may be employed which may be on both ends of the tube 100, one end of the tube 100 and/or may or may not be around the circumference of the tube.

FIG. 2C illustrates a side view of an assembled fuse 200 utilizing a hollow tube 210 configured with the counter bores 225a, 225b at respective ends. Fuse 200 includes a first end cap 230, a second end cap 240 and a fusible element 220 disposed within the hollow tube 210 which forms an electrical connection between the end caps 230 and 240. The counter bores 225a, 225b are disposed in walls 210a of the tube at each end. The fusible element 220 extends diagonally through the cavity of the tube body 210. End caps 230 and 240, made from an electrically conductive material, are positioned on the two ends of the tube body 210 to form electrical contact with the fusible element 220 to form a mechanically rigid connection with the walls 210a of tube 210. The fusible element 220 is connected to the end caps 230, 240 by means of solder 255 which fills the spaces defined by the counter bores 225a, 225b. In particular, the counter bores 225a, 225b in the walls 210a of tube body 210 are configured as having a step configuration. These counter bores provide extra space for the solder 255 to fill at the ends of the tube body 210. This extra solder covers a length of the fusible element 220 to provide a more reliable connection between the fusible element 220 and the respective end cap 230, 240.

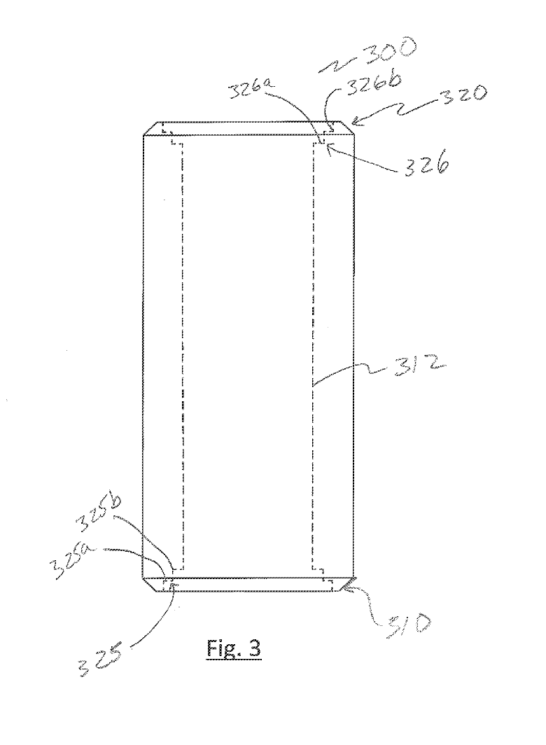

FIG. 3 illustrates a tube body 300 having an alternative configuration of counter bores 325, 326. In particular, tube body 300 has a first end 310 and a second end 320. Each end includes counter bores 325, 326 formed into tube wall 312. Counter bore 325 is defined by a first step 325a and a second step 325b. Counter bore 326 is defined by a first step 326a and a second step 326b. Similar to the tube body 210 shown in FIGS. 2A-2C, the counter bores 325, 326 at each end of tube body 300 provide extra space for the solder to cover a fusible element disposed inside the tube which provides a more reliable connection between the fusible element and respective end caps attached to the tube.

FIG. 4A is an end view of a tube body having an alternative configuration of counter bores. In particular, tube body 400 includes a cavity 411 defined by interior wall 412. The interior cavity may be circular, rectangular or other shape configured to house a fusible element. A first end 410 of the tube 400 includes a counter bore 425a formed into the wall 412 of tube 400. Counter bore 425a is shown as having an extended oval-like pointed shape. FIG. 4b is a cut away view of tube 400 taken along lines A-A of FIG. 4A. Tube 400 includes first end 410 and second end 420. An interior wall 412 defines cavity 411 which is configured to receive a fusible element (not shown). Counter bore 425a is disposed in wall 412 at end 410 of tube 400. Counter bore 425b is disposed in wall 412 at end 420 of tube 400. The counter bores 425a and 425b provide a more consistent point of connection between the solder or other conductive material and a fusible element.

FIG. 5A is an end view of a tube body having an alternative configuration of counter bores. In particular, tube body 500 includes a cavity 511 defined by interior wall 512. The interior cavity may be circular, rectangular or other shape configured to house a fusible element. First end 510 of the tube 500 includes a counter bore formed into wall 512. The counter bore is defined by a pair of circular portions 525a, 525b disposed along first end 510. FIG. 5b is a cut away view of tube 500 taken along lines B-B of FIG. 5A. Tube 500 includes first end 510 and second end 520. The interior wall 512 defines cavity 511 which is configured to receive a fusible element (not shown). A first end 510 of tube 500 includes a counter bore 525a disposed in wall 512. A second end 520 of tube 500 includes a counter bore 526a disposed in wall 512.

FIG. 6A is an end view of a tube body having an alternative configuration of counter bores. In particular, tube body 600 includes a cavity 611 defined by interior wall 612. The interior cavity may be circular, rectangular or other shape configured to house a fusible element. First end 610 of the tube 600 includes a counter bore 625a formed into the wall 612 of tube 600. Counter bore 625a is shown as having a generally square or rectangular shape. FIG. 6b is a cut away view of tube 600 taken along lines C-C of FIG. 6A. Tube 600 includes first end 610 and second end 620. Interior wall 612 defines cavity 611 and includes counter bore 625a disposed in wall 612 at end 610 of tube 600. Similarly, counter bore 625b is disposed in wall 612 at end 620 of tube 600.

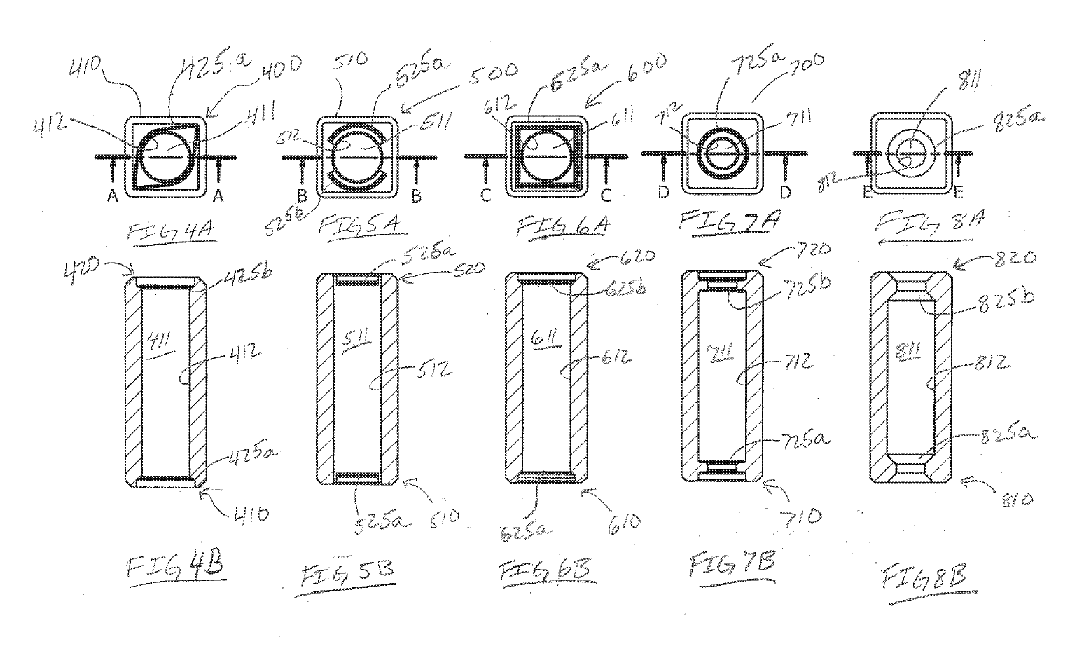

FIG. 7A is an end view of a tube body having an alternative configuration of counter bores. In particular, tube body 700 includes a cavity 711 defined by interior wall 712. The interior cavity may be circular, rectangular or other shape configured to house a fusible element. A first end 710 of the tube 700 includes a counter bore 725a formed into the wall 712. Counter bore 725a is shown as having a generally circular shape.

FIG. 7b is a cut away view of tube 700 taken along lines D-D of FIG. 7A. Tube 700 includes first end 710 and second end 720. Interior wall 712 defines cavity 711 which is configured to receive a fusible element (not shown). Counter bore 725a is disposed in wall 712 at end 710 of tube 700. Similarly, counter bore 725b is disposed in wall 712 at end 720.

FIG. 8A is an end view of a tube body having an alternative configuration of counter bores. In particular, tube body 800 includes a cavity 811 defined by interior wall 812. The interior cavity may be circular, rectangular or other shape configured to house a fusible element. A first end 810 of the tube 800 includes a counter bore 825a formed into the wall 812. Counter bore 825a is shown as having a partial cone shape as can be seen more clearly in FIG. 8b which is a cut away view of tube 800 taken along lines E-E of FIG. 8A. Tube 800 includes first end 810 and second end 820. Interior wall 812 defines cavity 811 which is configured to receive a fusible element (not shown). Counter bore 825a is disposed in wall 812 at end 810 of tube 800. Similarly, counter bore 825b is disposed in wall 812 at end 820.

In this manner, each of the counter bore configurations illustrated above with reference to FIGS. 4-8 provide a more consistent point of connection between the solder or other conductive material and a fusible element.

While the present invention has been disclosed with reference to certain embodiments, numerous modifications, alterations and changes to the described embodiments are possible without departing from the sphere and scope of the present invention, as defined in the appended claim(s). Accordingly, it is intended that the present invention not be limited to the described embodiments, but that it has the full scope defined by the language of the following claims, and equivalents thereof.

What is claimed is:

1. A fuse comprising:
a hollow body defining a central cavity, said hollow body having at least one end and a counter bore configured to receive solder;
a fusible element passing through the body; and
a cap disposed on said end of said hollow body, wherein said solder forms an electrical connection between said cap and said fusible element proximate said counter bore.

2. The fuse of claim 1 wherein said central cavity is defined by an inner wall of said hollow body, said counter bore disposed within said wall at said end of said hollow body.

3. The fuse of claim 2 wherein a portion of said solder at least partially fills said counter bore to form an electrical connection between said cap and said fusible element.

4. The fuse of claim 3 wherein said fusible element has a first end disposed at least partially within said counter bore for connection to said solder and said cap.

5. The fuse of claim 1 wherein said central cavity is defined by an inner wall of said hollow body, said counter bore defining a pocket within said wall.

6. The fuse of claim 1 wherein said central cavity is defined by an inner wall of said hollow body and said counter bore is defined by a first portion extending into a surface of said inner wall perpendicular to a longitudinal axis of said central cavity and a second portion extending toward said end of said hollow body parallel to said longitudinal axis of said central cavity.

7. The fuse of claim 1 wherein said end is a first end, said cap is a first cap and said fusible element has a first and second end, said first end of said fusible element forming said electrical connection with said first cap, said fuse further comprising a second end of said hollow body and a second cap, said second cap disposed on said second end of said hollow body wherein said solder forms an electrical connection between said second cap and said second end of said fusible element.

8. The fuse of claim 7 wherein said first end of said fusible element is disposed at least partially in said counter bore for connection to said solder and said first cap.

9. The fuse of claim 7 wherein said counter bore is a first counter bore, said second end of said hollow body having a second counter bore configured to receive solder forming the electrical connection between said second cap and said second end of said fusible element.

10. The fuse of claim 9 wherein said second end of said fusible element is disposed at least partially in said second counter bore for connection to said solder and said second cap.

11. The fuse of claim 9 wherein said central cavity is defined by an inner wall of said hollow body, said second counter bore disposed within said wall at said second end of said hollow body.

12. A fuse comprising:
a hollow body having an interior wall that defines a central cavity, said hollow body having a first end and a second end;
a counter bore disposed within said interior wall at said first end;
a solder material disposed within said counter bore;
a fusible element disposed within said central cavity and extending from said first end of said hollow body to said second end of said hollow body, said fusible element having a first end attached to said solder material proximate said counter bore; and
a cap attached to said first end of said hollow body, said solder material forming an electrical connection between said cap and said first end of said fusible element.

13. The fuse of claim 12 wherein said counter bore defines a pocket within said inner wall.

14. The fuse of claim 12 wherein said first end of said fusible element is disposed at least partially in said counter bore for connection to said solder material and said cap.

15. The fuse of claim 12 wherein said counter bore is a first counter bore, said solder material is a first solder material, said cap is a first cap and said fusible element has a second end, said fuse further comprising:
a second counter bore disposed within said interior wall at said second end of said hollow body;
a second solder material disposed within said second counter bore; and
a second cap attached to said second end of said hollow body, said second solder material forming an electrical connection between said second cap and said second end of said fusible element.

16. The fuse of claim 15 wherein said second end of said fusible element is disposed at least partially in said second counter bore for connection to said solder material and said second cap.

17. The fuse of claim 15 wherein said second counter bore defines a pocket within said inner wall.
